(19) United States
(12) Patent Application Publication
(10) Pub. No.: US 2023/0106962 A1
(43) Pub. Date: Apr. 6, 2023

(54) SKILL EVALUATION DEVICE AND SKILL EVALUATION METHOD

(71) Applicant: Panasonic Intellectual Property Management Co., Ltd., Osaka (JP)

(72) Inventors: Akira MINEGISHI, Osaka (JP); Yuta SHIMAZAKI, Osaka (JP); Yukinori SASAKI, Hyogo (JP)

(21) Appl. No.: 17/800,477

(22) PCT Filed: Mar. 3, 2021
(86) PCT No.: PCT/JP2021/008210

§ 371 Date: Aug. 17, 2022

(30) Foreign Application Priority Data
Mar. 11, 2020 (JP) 2020-042472

(51) Int. Cl. G06Q 10/0639

(52) U.S. Cl. CPC G06Q 10/06398

(57) ABSTRACT

A skill evaluation device includes: a first extractor that obtains first information indicating one or more types of first products, machines used in the production, and skill indicators of workers involved in the production; a model generator that generates an estimation model for estimating a standard probability distribution of a skill indicator; an aggregator that calculates a skill indicator by aggregating production records of the specified worker; an indicator estimator that estimates a probability distribution of the skill indicator for the specified worker by providing, as input data to the estimation model, second information indicating: one or more types of second products the specified worker has been involved in production; and one or more machines used by the specified worker; and an evaluator that calculates a deviation degree between the probability distribution estimated by the indicator estimator and the skill indicator calculated by the aggregator.

### CROSS-REFERENCE TO RELATED APPLICATIONS

This application is the U.S. National Phase under 35 U.S.C. § 371 of International Patent Application No. PCT/JP2021/008210, filed on Mar. 3, 2021, which in turn claims the benefit of Japanese Patent Application No. 2020-042472, filed on Mar. 11, 2020, the entire content of each of which is incorporated herein by reference.

### TECHNICAL FIELD

The present disclosure relates to a skill evaluation device and a skill evaluation method.

### BACKGROUND ART

Recently, a method for evaluating a worker skill based on the takt of the worker has been known (for example, see Patent Literature 1).

### CITATION LIST

### Patent Literature

[PTL 1] Japanese Unexamined Patent Application Publication No. 7-129680

### SUMMARY OF INVENTION

### Technical Problem

In a production system that produces multiple types of products, the types of products and machines handled by workers are different for each of the workers. The different type of product and the different machine require a different worker skill. Accordingly, even when the above-mentioned conventional evaluation method is applied, the worker skill cannot be equally evaluated.

In view of this, the present disclosure provides a skill evaluation device and a skill evaluation method that can equally evaluate the worker skill.

### Solution to Problem

A skill evaluation device according to one aspect of the present disclosure includes: an obtainer that obtains first information indicating one or more types of first products produced during a first time period, machines used in production of the first products, and skill indicators of workers involved in production of the first products; a model generator that generates an estimation model for estimating a standard probability distribution of a skill indicator in the first time period, using the first information; an aggregator that calculates a skill indicator of a specified worker by aggregating production records of the specified worker in a second time period; an estimator that estimates a probability distribution of the skill indicator for the specified worker by providing, as input data to the estimation model, second information indicating: one or more types of second products the specified worker has been involved in production of during the second time period; and one or more machines used by the specified worker during the second time period; a calculator that calculates a deviation degree between the probability distribution estimated by the estimator and the skill indicator calculated by the aggregator; and an output unit that outputs information based on the deviation degree.

A skill evaluation method according to one aspect of the present disclosure includes: obtaining first information indicating one or more types of first products produced during a first time period, machines used in production of the first products, and skill indicators of workers involved in production of the first products; generating an estimation model for estimating a standard probability distribution of a skill indicator in the first time period, using the first information; calculating a skill indicator of a specified worker by aggregating production records of the specified worker in a second time period; estimating a probability distribution of the skill indicator for the specified worker by providing, as input data to the estimation model, second information indicating: one or more types of second products the specified worker has been involved in production of during the second time period; and one or more machines used by the specified worker during the second time period; calculating a deviation degree between the probability distribution estimated in the estimating and the skill indicator calculated in the calculating of the skill indicator; and outputting information based on the deviation degree.

Moreover, one aspect of the present disclosure can be implemented as a program that causes a computer to execute the skill evaluation method. Alternatively, it is also possible to be implemented as a non-transitory computer readable medium storing the program.

### Advantageous Effects of Invention

According to the present disclosure, it is possible to equally evaluate the worker skill.

### BRIEF DESCRIPTION OF DRAWINGS

FIG. 1 is a diagram illustrating a production system according to Embodiment 1.

FIG. 2 is a diagram illustrating a relationship between a product type and a machine in the production system shown in FIG. 1.

FIG. 3 is a diagram illustrating one example of production record data accumulated in a storage according to Embodiment 1.

FIG. 4 is a block diagram illustrating the configuration of the skill evaluation device according to Embodiment 1.

FIG. 5 is a diagram illustrating a deviation degree between a standard productivity indicator distribution and a worker productivity indicator.

FIG. 6 is a flow chart illustrating a process of generating a standard production model among operations of the skill evaluation device according to Embodiment 1.

FIG. 7 is a flow chart illustrating a process of evaluating worker productivity among the operations of the skill evaluation device according to Embodiment 1.

FIG. 8 is a flow chart illustrating a process of evaluating worker productivity for each worker among the operations of the skill evaluation device according to Embodiment 1.

FIG. 9 is a diagram illustrating an example of a score display by the skill evaluation device according to Embodiment 1.

FIG. 10 is a diagram illustrating one example of stoppage history data accumulated in a storage according to Embodiment 2.

FIG. 11 is a block diagram illustrating the configuration of the skill evaluation device according to Embodiment 2.

FIG. 12 is a flow chart illustrating a process of generating a standard machine downtime model among operations of the skill evaluation device according to Embodiment 2.

FIG. 13 is a flow chart illustrating a process of evaluating the machine downtime of a worker among the operations of the skill evaluation device according to Embodiment 2.

FIG. 14 is a diagram illustrating an example of a score display by the skill evaluation device according to Embodiment 2.

### DESCRIPTION OF EMBODIMENTS

(Outlines of Present Disclosure)

A skill evaluation device according to one aspect of the present disclosure includes: an obtainer that obtains first information indicating one or more types of first products produced during a first time period, machines used in production of the first products, and skill indicators of workers involved in production of the first products; a model generator that generates an estimation model for estimating a standard probability distribution of a skill indicator in the first time period, using the first information; an aggregator that calculates a skill indicator of a specified worker by aggregating production records of the specified worker in a second time period; an estimator that estimates a probability distribution of the skill indicator for the specified worker by providing, as input data to the estimation model, second information indicating: one or more types of second products the specified worker has been involved in production of during the second time period; and one or more machines used by the specified worker during the second time period; a calculator that calculates a deviation degree between the probability distribution estimated by the estimator and the skill indicator calculated by the aggregator; and an output unit that outputs information based on the deviation degree.

With this, the probability distribution of the skill indicator for the specified worker to be estimated by the estimator is obtained by inputting information indicating the product types and the machines handled by the specified worker into the estimation model that estimates the standard probability distribution of the skill indicator, and thus represents the standard probability distribution of the skill indicator under the production condition for the specific worker. Accordingly, it is possible to determine whether the skill of the specified worker is high or low by comparing the skill indicator obtained from the aggregate result of the records of the specified worker with the estimated probability distribution of the skill indicator. More specifically, the calculated deviation degree is a quantified numerical value of whether the skill of the specified worker is high or low. As described above, in the skill evaluation device according to the present aspect, whether the skill is high or low can be determined based on the standard probability distribution of the skill indicator, and thus it is possible to equally evaluate the worker skill.

Moreover, for example, the skill indicator may be an indicator indicating worker productivity.

With this, it is possible to equally evaluate the worker productivity.

Moreover, for example, the skill indicator may be a machine downtime required for a worker to restart a stopped machine.

With this, it is possible to equally evaluate the worker ability to restart the machine (restoring ability or maintenance ability).

Moreover, for example, the aggregator may calculate the machine downtime for each of machine stoppage factors by aggregating the production records of the specified worker in the second time period for each of the machine stoppage factors, and the calculator may calculate the deviation degree for each of the machine stoppage factors.

With this, the restoring ability can be evaluated for each machine stoppage factor, and thus it is possible to identify a good skill or a poor skill of the worker.

Moreover, for example, the calculator may identify a poor skill of the specified worker based on the deviation degree for each of the machine stoppage factors.

With this, a poor skill of the worker can be identified, and thus it is possible to assist the determination of training details needed to compensate for the poor skill.

Moreover, for example, the specified worker may comprise a plurality of specified workers, the aggregator may calculate the skill indicator for each of the plurality of specified workers, the estimator may calculate the probability distribution of the skill indicator for each of the plurality of specified workers, and the calculator may calculate the deviation degree for each of the plurality of specified workers.

With this, it is possible to easily compare the skill among the workers.

Moreover, for example, the skill evaluation device according to one aspect of the present disclosure further includes an input receiver that receives an input of the second time period and an input of one or more specified workers.

With this, it is possible to specify the time period during which the skill is to be evaluated and the worker for whom the skill is to be evaluated.

Moreover, a skill evaluation method according to one aspect of the present disclosure includes: obtaining first information indicating one or more types of first products produced during a first time period, machines used in production of the first products, and skill indicators of workers involved in production of the first products; generating an estimation model for estimating a standard probability distribution of a skill indicator in the first time period, using the first information; calculating a skill indicator of a specified worker by aggregating production records of the specified worker in a second time period; estimating a probability distribution of the skill indicator for the specified worker by providing, as input data to the estimation model, second information indicating: one or more types of second products the specified worker has been involved in production of during the second time period; and one or more machines used by the specified worker during the second time period; calculating a deviation degree between the probability distribution estimated in the estimating and the skill indicator calculated in the calculating of the skill indicator; and outputting information based on the deviation degree.

With this, as with the above skill evaluation device, it is possible to equally evaluate the worker skill.

Moreover, a recording medium according to one aspect of the present disclosure is a non-transitory computer-readable recording medium for use in a computer. The recording medium has a program recorded thereon for causing the computer to execute the skill evaluation method described above.

With this, as with the above skill evaluation device, it is possible to equally evaluate the worker skill.

The following describes the embodiments in detail with reference to drawings.

The embodiments described below show general or specific examples. The numerical values, shapes, materials, structural elements, the arrangement and connection of the structural elements, steps, the processing order of the steps etc. shown in the following embodiments are mere examples, and thus do not limit the scope of the present disclosure. Among the structural elements in the following embodiments, structural elements not recited in any of the independent claims are described as arbitrary structural elements.

The figures are schematic illustrations and not necessarily precise illustrations. Accordingly, for example, the scale of each figure may be different. In the figures, substantially identical components are assigned the same reference signs, and overlapping descriptions thereof are omitted or simplified.

### Embodiment 1

[1-1. Production System]

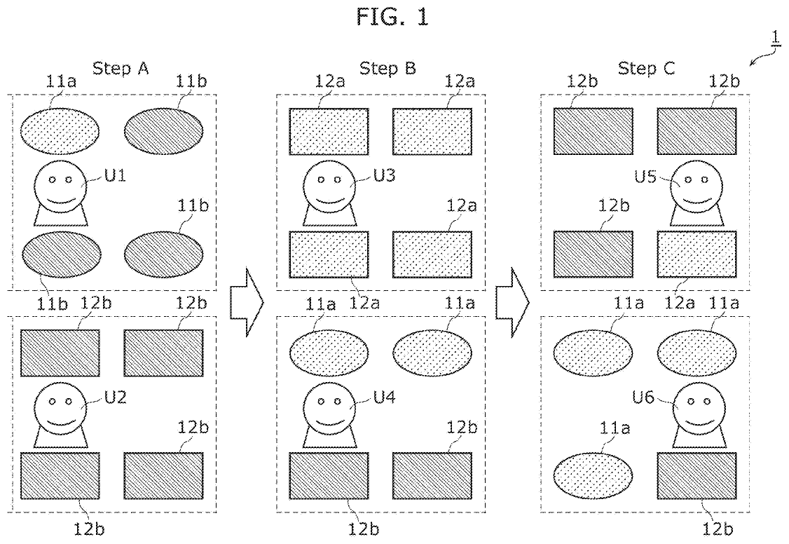

First, the outline of a production system to which a skill evaluation device according to Embodiment 1 applies will be described with reference to FIG. 1. FIG. 1 is a diagram illustrating the production system according to Embodiment 1.

In production system 1 shown in FIG. 1, products are produced through three steps A to C in turn. Steps A to C are, for example, an assembly step, a welding step, and a packaging (packing) step, respectively. It is to be noted that the specific example of the number of steps and the steps is merely one example. Other examples are possible. The products produced by production system 1 are, for example, electric appliances. However, mounting boards with multiple circuit components or circuit components are possible.

Production system 1 according to Embodiment 1 includes multiple machines, and produces multiple types of products. Production system 1 includes multiple machines for each step. As shown in FIG. 1, two workers are assigned for each step. Four machines per person are assigned to each of workers U1 to U6. Each worker performs product production by operating the assigned machines. Moreover, when an assigned machine is down, each worker performs maintenance of the assigned machine and restarts the assigned machine.

The types of products and the types of machines handled by workers U1 to U6 are different for each of the workers. In FIG. 1, a combination of the type of product and the type of machine is denoted by a difference in hatching and a difference in symbolized shape of the machine.

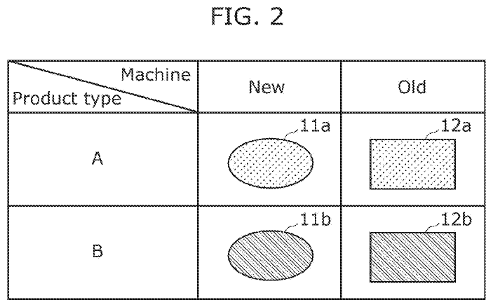

FIG. 2 is a diagram illustrating a relationship between the product type and the machine in the production system shown in FIG. 1. As shown in FIG. 2, there are two types of product: product type A; and product type B. There are two types of machine: a new machine; and an old machine. Accordingly, the combination of the product type and the machine includes four patterns: product type A is processed on the new machine; product type A is processed on the old machine; product type B is processed on the new machine; and product type B is processed on the old machine. In order to differentiate these four patterns from one another, the new machine for processing product type A is defined as machine 11a, the old machine for processing product type A is defined as machine 12a, the new machine for processing product type B is defined as machine 11b, and the old machine for processing product type B is defined as machine 12b.

The product types and the machines are different for each worker, and thus the worker skill cannot be determined whether to be high or low even when the indicator indicating the worker productivity (e.g., a production time required for one product, i.e., a takt time) is simply compared among the workers. For example, in the example shown in FIG. 1, when product type A is easier in production than product type B, workers U3 and U6 who handle more products of type A have an advantage. Alternatively, when the productivity of the new machine is higher than that of the old machine, workers U1 and U6 who uses more new machines have an advantage. As described above, the indicator indicating the productivity such as the takt time cannot be used as an indicator for equally evaluating the skill among the workers.

Moreover, workers U1 to U6 are not always involved in production of the same type of the product using the same machine. The assigned machine and product type may be changed according to day or time. There are many combinations of the machines and the product types assigned to workers U1 to U6, and thus it is difficult to compare the skill among the workers under a determined uniform condition.

In contrast, the skill evaluation device according to Embodiment 1 generates an estimation model for estimating a standard probability distribution of a skill indicator based on the production records of the workers. This estimation model can be used to obtain the standard probability distribution of the skill indicator under the production condition for the specific worker. Whether the skill is high or low can be determined based on the standard probability distribution of the skill indicator, and thus it is possible to equally evaluate the worker skill. In Embodiment 1, a productivity indicator indicating the worker productivity is used as one example of a skill indicator.

[1-2. Production Record Data]

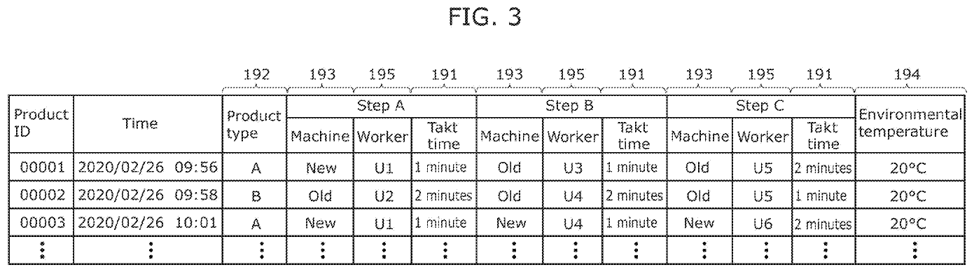

Next, production record data for use in the skill evaluation device according to Embodiment 1 will be described with reference to FIG. 3. FIG. 3 is a diagram illustrating one example of production record data accumulated in a storage according to Embodiment 1.

As shown in FIG. 3, in the production record data, for each product, an identification number of the product (product ID), production time of the product, productivity indicator information 191, product type information 192, machine information 193, environment information 194, and worker information 195 are associated with one another. Machine information 193, worker information 195, and productivity indicator information 191 are further associated with one another for each step.

Productivity indicator information 191 indicates the productivity indicator of the worker involved in production of the corresponding product (first product). The productivity indicator is, for example, a takt time. The shorter takt time is indicated, the more products can be produced during a short period of time. Accordingly, the productivity is high. Alternatively, the productivity indicator may be the number of produced products per unit time. The productivity is higher as the number of produced products per unit time increases.

Product type information 192 indicates the type of the corresponding product. It is to be noted that the type indicated by product type information 192 may mean categories for each product type. In other words, product type information 192 may be category information indicating categories into which the product type is further classified.

Machine information 193 indicates the machine used for production of the corresponding product.

Environment information 194 indicates an environmental value during production of the corresponding product. The environmental value is, for example, a room temperature and a humidity in a space where the product is produced. Alternatively, the environmental value may be the temperature of the product or the machine

Worker information 195 indicates a worker involved in production of the corresponding product.

The production record data is generated based on production log information of production system 1 or the like. The data format of the production record data is not particularly limited. For example, the production record data may include above information items associated with one another for each machine. Alternatively, the production record data may include above information items associated with one another for each worker. Furthermore, the production record data need not include environment information 194.

[1-3. Skill Evaluation Device]

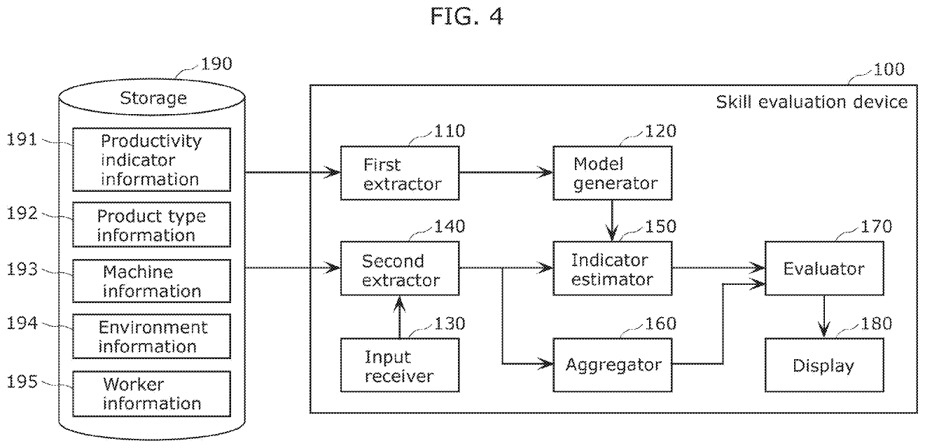

Next, the configuration of the skill evaluation device according to Embodiment 1 will be described with reference to FIG. 4. FIG. 4 is a block diagram illustrating the configuration of the skill evaluation device according to Embodiment 1.

As shown in FIG. 4, skill evaluation device 100 includes first extractor 110, model generator 120, input receiver 130, second extractor 140, indicator estimator 150, aggregator 160, evaluator 170, and display 180. It is to be noted that skill evaluation device 100 evaluates a worker skill using information accumulated in storage 190. Storage 190 accumulates, for example, production record data shown in FIG. 3. In other words, storage 190 stores productivity indicator information 191, product type information 192, machine information 193, environment information 194, and worker information 195. It is to be noted that storage 190 is a non-volatility storage element such as a Hard Disk Drive (HDD) or a flash memory.

First extractor 110 is one example of an obtainer that obtains the first information. The first information indicates: one or more types of the first products produced during a modeling time period; machines used in production of the first products; and productivity indicators of workers involved in production of the first products. More specifically, the first information includes productivity indicator information 191, product type information 192, and machine information 193. In Embodiment 1, the first information further includes environment information 194. First extractor 110 extracts productivity indicator information 191, product type information 192, machine information 193, and environment information 194 which are associated with a time included in the modeling time period, from the production record data accumulated in storage 190.

The modeling time period is one example of the first time period, and a time period during which production is performed to obtain production record data for use in generating an estimation model. The modeling time period precedes a time when the worker skill is evaluated and a time when the estimation model is generated. More specifically, the modeling time period is a certain period of time such as one day, one week, one month, or one year. The modeling time period is, for example, a past time period during which the products of the same type as that of products currently being produced have been produced using the same machines as those currently being used. The modeling time period may be an entire period from establishment of production system 1 to the present time.

Model generator 120 generates an estimation model for estimating the standard probability distribution of a productivity indicator in the modeling time period, using the first information obtained by first extractor 110. Model generator 120 generates the estimation model based on, for example, Bayesian estimation. In particular, model generator 120 calculates parameters for defining the estimation model using the first information. More specifically, model generator 120 calculates parameters of a hierarchical Bayesian model using information in the modeling time period. The hierarchical Bayesian model according to Embodiment 1 takes the product type information and the machine information as explanatory variables, and estimates not only the productivity indicator and its frequency for each production condition, but also a total productivity indicator. The total productivity indicator is a value obtained by dividing a product sum of the productivity indicator and the frequency by the frequency (an average).

In Embodiment 1, the estimation model is a standard production model, and a model for estimating the standard probability distribution of a productivity indicator under a predetermined production condition. Model generator 120 generates the standard production model using all the production records during the modeling time period among the past production records. It is to be noted that all the production records during the modeling time period specifically refers to productivity indicator information 191, product type information 192, machine information 193, and environment information 194. In this case, environment information 194 is optional. When a production condition for a specified worker is provided as input data, the standard production model outputs, as output data, the standard probability distribution of the productivity indicator under the production condition for the specified worker (hereinafter, referred to as a standard productivity indicator distribution). It is to be noted that the production condition is defined by a combination of the product type, the machine, and the environmental value. The production condition may be defined by a combination of the product type and the machine, except the environmental value.

Input receiver 130 receives an input of an evaluation time period and an input of a specified worker. The specified worker is a worker whose skill is to be evaluated. The evaluation time period is one example of the second time period, and a target period for skill evaluation. For example, the evaluation time period is different from the modeling time period. The evaluation time period may be a part of the modeling time period, or a period including a part of the modeling time period.

Input receiver 130 is implemented by, for example, an input device such as a touch panel display, a keyboard, or a mouse. For example, input receiver 130 displays a text box for inputting the evaluation time period, list information for selecting the specific worker, and the like on a display. The list information indicates, for example, all the workers included in the production record data.

With this, it is possible to prompt a user of skill evaluation device 100 (e.g., a manager of production system 1) or the like to input the evaluation time period and the specified worker, and input receiver 130 receives the inputted period and the inputted worker as the evaluation time period and the specified worker, respectively. It is to be noted that input receiver 130 may be implemented by a micro phone and receive a voice input. The input format of the evaluation time period and the specified worker is not particularly limited.

The evaluation time period is a certain period of time such as one hour, one day, one week, or one month, and another period is possible. Input receiver 130 may receive only the input of the specified worker without receiving the input of the evaluation time period. It is to be noted that input receiver 130 may receive an input of multiple specified workers.

Second extractor 140 extracts the production record data related to the evaluation time period and the specified worker received by input receiver 130 from storage 190. More specifically, second extractor 140 extracts production record data regarding products which have been produced during the evaluation time period (second products) and the specified worker has been involved in production of. For example, in the example shown in FIG. 3, when the evaluation time period is all day of 2020 Feb. 26 and the specified worker is worker U4, second extractor 140 extracts machine information 193 and productivity indicator information 191 related to step B, product type information 192, and environment information 194 for each of product ID “00002” and product ID “00003”.

Indicator estimator 150 estimates the probability distribution of the productivity indicator for the specified worker by providing, as input data to the estimation model, the second information indicating: one or more types of products the specified worker has been involved in production of during the evaluation time period (second products); and one or more machines used by the specified worker during the evaluation time period. In Embodiment 1, the second information further indicates an environmental value (e.g., a room temperature) related to the specified worker in the evaluation time period. In other words, indicator estimator 150 provides product type information 192, machine information 193, and environment information 194 related to the specified worker in the evaluation time period as input data to the estimation model.

The estimated probability distribution is a standard probability distribution of the productivity indicator under the production condition for the specified worker in the evaluation time period. It is possible to determine whether the productivity of the specified worker is high or low by comparing the records of the specified worker with the estimated probability distribution.

Aggregator 160 calculates the productivity indicator of the specified worker by aggregating the production records of the specified worker in the evaluation time period. More specifically, aggregator 160 calculates, as the productivity indicator of the specified worker, a statistic such as a productivity-indicator average or variance of the specified worker in the evaluation time period. For example, when the specified worker handles multiple product types and multiple machines during the evaluation time period, aggregator 160 calculates a productivity-indicator average or variance for each combination of the product type and the machine.

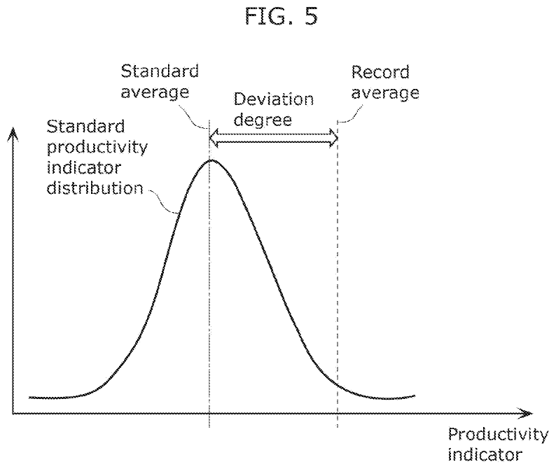

Evaluator 170 is one example of a calculator that calculates a deviation degree between the probability distribution estimated by indicator estimator 150 (i.e., the standard productivity indicator distribution) and the productivity indicator calculated by aggregator 160. For example, evaluator 170 compares an average of the standard productivity indicator distribution (hereinafter, referred to as a standard average) with an average calculated by aggregator 160 (hereinafter, referred to as a record average). Alternatively, evaluator 170 may compare a variance of the standard productivity indicator distribution with a variance calculated by aggregator 160. FIG. 5 is a diagram illustrating the deviation degree between the standard productivity indicator distribution and the worker productivity indicator. As shown in FIG. 5, evaluator 170 can calculate a difference between the standard average and the record average as the deviation degree. It is to be noted that the deviation degree may be a difference between variances of these two. Alternatively, the deviation degree may be an average ratio or a variance ratio.

In Embodiment 1, evaluator 170 changes the deviation degree to a score. The score is an evaluation value indicating a level of the skill. For example, the score is represented in a range of points from 0 to 10, and the higher the score is, the higher the skill is.

For example, the score can be represented by a linear function. For example, when the deviation degree is a value obtained by subtracting the standard average from the record average, the deviation degree of 0 means that the worker skill is standard. Accordingly, for example, when the deviation degree is 0, evaluator 170 sets the score to 5 which is an intermediate value. The deviation degree of a positive value means that the worker skill is higher than the standard, and thus evaluator 170 sets the score to a value greater than 5 and less than or equal to 10. The deviation degree of a negative value means that the worker skill is lower than the standard, and thus evaluator 170 sets the score to a value greater than or equal to 0 and less than 5.

It is to be noted that when the specified worker handles multiple product types and multiple machines during the evaluation time period, evaluator 170 calculates, for each combination of the product type and the machine, the deviation degree based on the standard productivity indicator distribution and the productivity indicator calculated by aggregator 160 for each combination of the product type and the machine. Evaluator 170 further changes the calculated deviation degree into the score for each combination of the product type and the machine. Evaluator 170 calculates a total score by weighting the score for each combination of the product type and the machine using a ratio of a handling period of the combination by the specified worker to the evaluation time period and the number of products produced in the combination. The calculated total score is the score of the specified worker in the evaluation time period.

Display 180 is one example of an output unit that outputs information based on the deviation degree. In Embodiment 1, display 180 displays the score of the specified worker. The display example of display 180 will be described later.

Display 180 is, for example, a liquid crystal display device, but is not limited to this. Display 180 may be an organic electroluminescence (EL) display device.

It is to be noted that skill evaluation device 100 may include a sound output unit such as a speaker, or a communication unit, instead of display 180 or in addition to display 180. The sound output unit outputs the information based on the deviation degree as a sound. The communication unit may transmit a signal containing the information based on the deviation degree to another device. The communication by the communication unit may be wired or wireless.

Skill evaluation device 100 according to Embodiment 1 is, for example, a computer device. Skill evaluation device 100 is implemented by a non-volatility memory storing a program, a volatility memory which is a transitory storage area to execute a program, an input and output port, a processor that executes a program, and the like.

In Embodiment 1, each processing unit except input receiver 130 and display 180 is implemented by, for example, a large scale integration (LSI) circuit which is an integrated circuit (IC). The integrated circuit is not limited to the LSI circuit. A dedicated circuit or a general-purpose processor is also possible. For example, each processing unit may be a micro controller. Each processing unit also may be a field programmable gate array (FPGA) which is programmable, or a reconfigurable processor in which setting and connection of circuit cells in a LSI circuit are reconfigurable. The function performed by each processing unit may be implemented by a software or a hardware. Each processing unit may share hardware resources such as memory and processor.

[1-4. Operation]

Next, the operation performed by skill evaluation device 100 according to Embodiment 1 will be described.

[1-4-1. Generation of Standard Production Model]

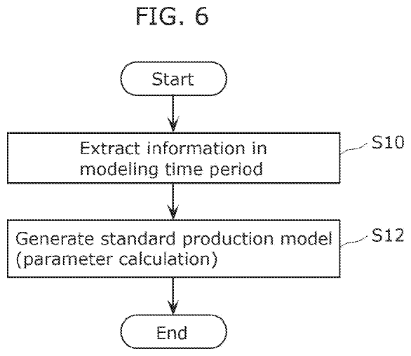

First, among operations performed by skill evaluation device 100 according to Embodiment 1, a process of generating the standard production model will be described with reference to FIG. 6. FIG. 6 is a flow chart illustrating the process of generating the standard production model among operations of the skill evaluation device according to Embodiment 1.

As shown in FIG. 6, first, first extractor 110 extracts information in the modeling time period (S10). More specifically, first extractor 110 extracts all production records except worker information 195 in the modeling time period from the past production records stored in storage 190. In other words, first extractor 110 extracts all productivity indicator information 191, product type information 192, machine information 193, and environment information 194 without filtering using a worker, a machine, a product type, an environmental value, and the like.

Next, model generator 120 generates the standard production model based on the extracted information (S12). More specifically, model generator 120 calculates parameters for defining the standard production model, based on Bayesian estimation.

The above process of generating the standard production model is performed prior to evaluation of the productivity of the specified worker. The process of generating the standard production model may be repeated every time the production record data is accumulated. For example, the process of generating the standard production model may be performed every day or every week.

[1-4-2. Evaluation of Productivity]

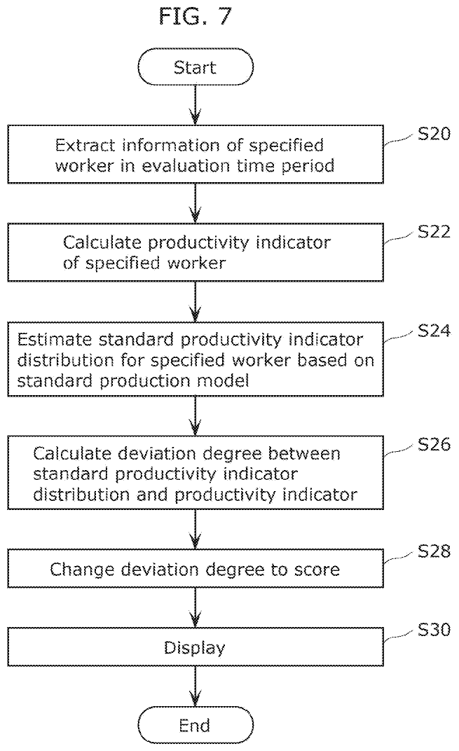

Next, among operations performed by skill evaluation device 100 according to Embodiment 1, a process of evaluating worker productivity will be described with reference to FIG. 7. FIG. 7 is a flow chart illustrating the process of evaluating the worker productivity among the operations of the skill evaluation device according to Embodiment 1.

As shown in FIG. 7, first, second extractor 140 extracts information of a specified worker in the evaluation time period (S20). It is to be noted that the specified worker and the evaluation time period is a worker and a time period received by input receiver 130, respectively. With reference to worker information 195, second extractor 140 extracts productivity indicator information 191, product type information 192, machine information 193, and environment information 194 related to products the specified worker has been involved in production of during the evaluation time period.

Next, aggregator 160 calculates the productivity indicator of the specified worker (S22). More specifically, aggregator 160 calculates an average productivity indicator by aggregating the production records of the specified worker.

Next, indicator estimator 150 estimates the standard productivity indicator distribution for the specified worker based on the standard production model generated by the process shown in FIG. 6 (S24). More specifically, indicator estimator 150 estimates the standard productivity indicator distribution by providing product type information 192, machine information 193, and environment information 194 extracted by second extractor 140, as input data to the standard production model.

It is to be noted that one of the process by aggregator 160 and the process by indicator estimator 150 may be performed before the other, or both of them may be performed in parallel.

Next, evaluator 170 calculates the deviation degree between the standard productivity indicator distribution and the productivity indicator (S26). Furthermore, evaluator 170 changes the calculated deviation degree to a score (S28). Next, display 180 displays the score obtained in evaluator 170 (S30).

As described above, in skill evaluation device 100 according to Embodiment 1, the standard productivity indicator distribution can be obtained based on the estimation model, and thus it is possible to equally evaluate the worker productivity by reducing the effects of the machines, the product types, and the like. Moreover, the productivity indicator can be quantitatively calculated for each worker, and thus it is possible to compare the productivity among the workers.

[1-4-3. Comparison of Productivity Among Workers]

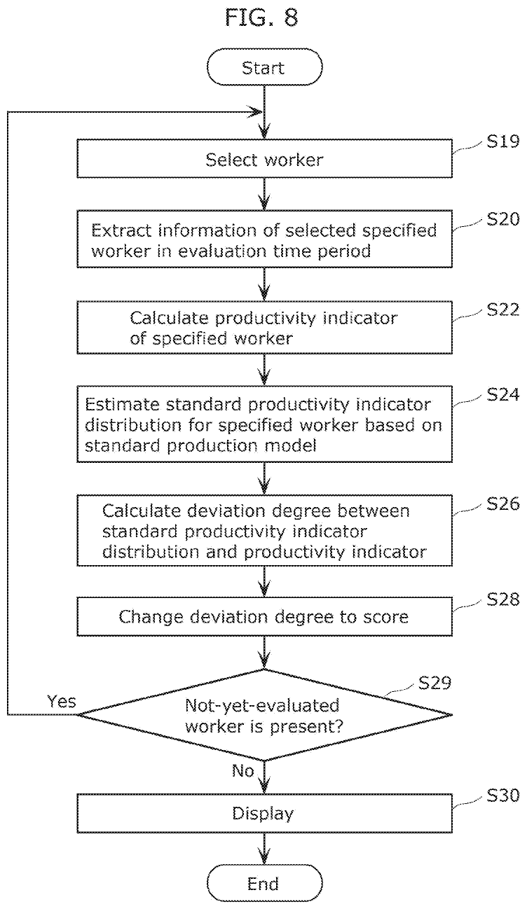

Next, a process of comparing the productivity among the workers will be described with reference to FIG. 8. FIG. 8 is a flow chart illustrating a process of evaluating the worker productivity for each worker among the operations of the skill evaluation device according to Embodiment 1.

As shown in FIG. 8, first, second extractor 140 selects one worker as the specified worker whose productivity indicator is to be calculated (S19). For example, when multiple workers are provided by input receiver 130, second extractor 140 selects a worker whose deviation degree and score are not yet calculated, i.e., a worker whose productivity is not yet evaluated, as the specified worker from among the provided workers.

Subsequent to this, extraction of the record data during the evaluation time period (S20), calculation of the productivity indicator (S22), estimation of the standard productivity indicator distribution (S24), calculation of the deviation degree (S26), and change to the score (S28) are performed on the selected specified worker in the same manner as the process shown in FIG. 7.

Next, second extractor 140 determines whether a not-yet-evaluated worker is present (S29). When a not-yet-evaluated worker is present (Yes in S29), second extractor 140 selects the not-yet-evaluated worker as the specified worker (S19), and repeats Steps S20 to S29. When a not-yet-evaluated worker is not present (No in S29), i.e., when evaluation of all the workers who are targets for the evaluation is finished, display 180 displays the score for each worker (S30).

It is to be noted that FIG. 8 shows an example in which multiple workers are targeted to evaluate the productivity for each worker, but multiple evaluation time periods may be targeted to evaluate the productivity of one or more workers. For example, input receiver 130 receives an input of multiple time periods. In this case, Steps S19 to S29 shown in FIG. 8 are performed for each evaluation time period.

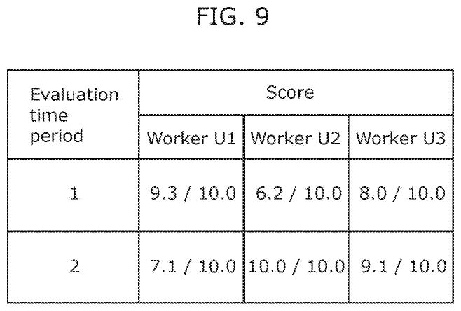

FIG. 9 is a diagram illustrating an example of a score display by the skill evaluation device according to Embodiment 1. As shown in FIG. 9, display 180 displays the score of each of the workers in a table format for each evaluation time period. In this manner, display 180 displays the score of each worker on the same screen, and thus the difference in skill among the workers can be easily known. Accordingly, for example, it is possible to easily identify a worker who lacks the skill and needs training.

It is to be noted that an example of the score display by display 180 is not particularly limited. For example, display 180 may display the score by sorting the workers in descending order of score. In this case, display 180 need not display a score value itself. Moreover, when the worker who is to be evaluated is only one, display 180 may display one or more scores of the one worker in one or more time periods.

### Embodiment 2

Subsequently, Embodiment 2 will be described.

In Embodiment 2, instead of the productivity indicator, a machine downtime is used as the worker skill indicator. The following focuses on the differences from Embodiment 1, and the common part description is omitted or simplified.

[2-1. Stoppage History Data]

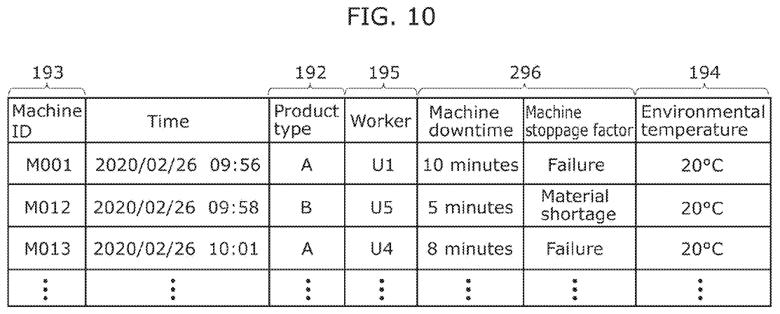

First, stoppage history data for use in the skill evaluation device according to Embodiment 2 will be described with reference to FIG. 10. FIG. 10 is a diagram illustrating one example of stoppage history data accumulated in a storage according to Embodiment 2. The stoppage history data is one example of the production record data generated in production system 1.

As shown in FIG. 10, in the stoppage history data, machine information 193 is associated with the occurrence time of machine stoppage, product type information 192, environment information 194, worker information 195, and stoppage information 296.

Product type information 192 indicates the type of a product being handled when the corresponding machine stopped.

Machine information 193 indicates, for example, a unique identifier (machine ID) assigned to each machine.

Environment information 194 indicates an environmental value when the corresponding machine stopped.

Worker information 195 indicates a worker who operates the corresponding machine and restarts this machine.

Stoppage information 296 includes a machine downtime and a machine stoppage factor. The machine downtime is a time required to restart the stopped corresponding machine. The machine stoppage factor is a factor causing the corresponding machine to stop.

The stoppage history data is generated based on production log information of production system 1 or the like. The data format of the stoppage history data is not particularly limited. For example, as with the production record data shown in FIG. 3, the stoppage history data may include above information items associated with one another for each production ID. Alternatively, the stoppage history data may include above information items associated with one another for each worker. Furthermore, the stoppage history data need not include environment information 194. Furthermore, the stoppage history data may include productivity indicator information 191.

[2-2. Skill Evaluation Device]

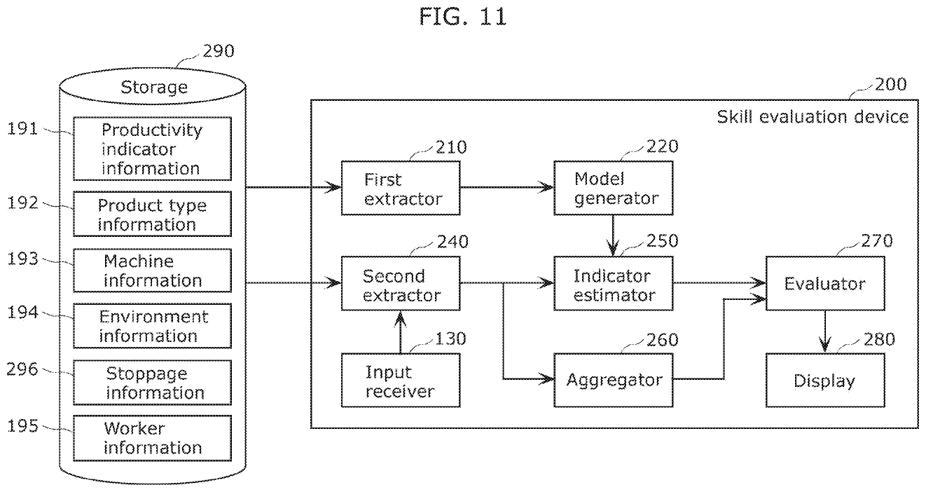

Next, the configuration of the skill evaluation device according to Embodiment 2 will be described with reference to FIG. 11. FIG. 11 is a block diagram illustrating the configuration of the skill evaluation device according to Embodiment 2.

As shown in FIG. 11, skill evaluation device 200 includes first extractor 210, model generator 220, input receiver 130, second extractor 240, indicator estimator 250, aggregator 260, evaluator 270, and display 280. Input receiver 130 is the same as that of Embodiment 1.

It is to be noted that skill evaluation device 200 evaluates a worker skill using information accumulated in storage 290. Storage 290 accumulates, for example, stoppage history data shown in FIG. 10. In other words, storage 290 stores product type information 192, machine information 193, environment information 194, worker information 195, and stoppage information 296. Storage 290 may store productivity indicator information 191. It is to be noted that storage 290 is a non-volatility storage element such as a Hard Disk Drive (HDD) or a flash memory.

First extractor 210 is one example of an obtainer that obtains the first information. The first information indicates: one or more types of the first products produced during a modeling period; machines used in production of the first products; and a machine downtime required for each of workers involved in production of the first products to restart the stopped machine. More specifically, the first information includes product type information 192, machine information 193, and stoppage information 296. In Embodiment 2, the first information further includes environment information 194. In Embodiment 2, first extractor 210 extracts stoppage information 296, product type information 192, machine information 193, and environment information 194 which are associated with a time included in the modeling time period, from the stoppage history data stored in storage 290.

As is the case in Embodiment 1, the modeling time period is one example of the first time period, and a time period during which production is performed to obtain stoppage history data for use in generating an estimation model.

Model generator 220 generates an estimation model for estimating the probability distribution of a standard machine downtime in the modeling time period using the first information obtained by first extractor 210. Model generator 220 generates the estimation model based on, for example, Bayesian estimation. In particular, model generator 220 calculates parameters for defining the estimation model, using the first information. More specifically, model generator 220 calculates parameters of a hierarchical Bayesian model using information in the modeling time period. The hierarchical Bayesian model according to Embodiment 2 takes the product type information and the machine information as explanatory variables, and estimates not only the machine downtime and its frequency for each machine stoppage factor, but also a total machine downtime. The total machine downtime corresponds to a product sum of the machine downtime and the frequency for each machine stoppage factor.

In Embodiment 2, the estimation model is a standard machine downtime model, and a model for estimating the standard probability distribution of a machine downtime under a predetermined production condition. Model generator 220 generates the standard machine downtime model using all the stoppage history records during the modeling time period among the past stoppage history records. It is to be noted that all the stoppage history records during the modeling time period specifically refers to stoppage information 296, product type information 192, machine information 193, and environment information 194. In this case, environment information 194 is optional. When a production condition for a specified worker is provided as input data, the standard machine downtime model outputs, as output data, the standard probability distribution of the machine downtime under the production condition for the specified worker (hereinafter, referred to as a standard machine downtime distribution).

Second extractor 240 extracts the stoppage history data related to the evaluation time period and the specified worker received by input receiver 130 from storage 290. More specifically, second extractor 240 extracts stoppage history data regarding products which have been produced during the evaluation time period (second products) and the specified worker has been involved in production of. For example, in the example shown in FIG. 10, when the evaluation time period is all day of 2020 Feb. 26 and the specified worker is worker U4, second extractor 240 extracts stoppage information 296, product type information 192, environment information 194, and worker information 195 related to machine ID “M013”.

Indicator estimator 250 estimates the probability distribution of the machine downtime for the specified worker by providing, as input data to the estimation model, the second information indicating: one or more types of products the specified worker has been involved in production of during the evaluation time period (second products); and one or more machines used by the specified worker during the evaluation time period. In Embodiment 2, the second information further indicates an environmental value (e.g., a room temperature) related to the specified worker in the evaluation time period. In other words, indicator estimator 250 provides product type information 192, machine information 193, and environment information 194 related to the specified worker in the evaluation time period as input data to the estimation model.

The estimated probability distribution is a standard probability distribution of the machine downtime under the production condition for the specified worker in the evaluation time period. It is possible to determine whether the machine downtime of the specified worker is long or short by comparing the records of the specified worker with the estimated probability distribution. In Embodiment 2, indicator estimator 250 estimates the probability distribution of the machine downtime for each machine stoppage factor.

Aggregator 260 calculates the machine downtime of the specified worker by aggregating the production records of the specified worker in the evaluation time period. More specifically, aggregator 260 calculates, as the machine downtime of the specified worker, a statistic such as a machine-downtime average or variance of the specified worker in the evaluation time period. Aggregator 260 may calculate the machine downtime for each machine stoppage factor by aggregating the production records for each machine stoppage factor. For example, when the specified worker handles multiple product types and multiple machines during the evaluation time period, aggregator 260 calculates a machine-downtime average or variance for each machine stoppage factor of each of the machines and for each of the product types.

Evaluator 270 is one example of a calculator that calculates a deviation degree between the probability distribution estimated by indicator estimator 250 (i.e., the standard machine downtime distribution) and the machine downtime calculated by aggregator 260. For example, evaluator 270 compares an average of the standard machine downtime distribution (hereinafter, referred to as a standard average) with an average calculated by aggregator 260 (hereinafter, referred to as a record average). Alternatively, evaluator 270 may compare a variance of the standard machine downtime distribution with a variance calculated by aggregator 260.

In Embodiment 2, evaluator 270 changes the deviation degree to a score. As is the case in Embodiment 1, for example, the score can be represented by a linear function. For example, when the deviation degree is a value obtained by subtracting the standard average from the record average, the deviation degree of 0 means that the machine downtime of the worker is standard. Accordingly, for example, when the deviation degree is 0, evaluator 270 sets the score to 5 which is an intermediate value. The deviation degree of a negative value means that the machine downtime of the worker is shorter than the standard, and thus evaluator 270 sets the score to a value greater than 5 and less than or equal to 10 when the deviation degree is a negative value. The deviation degree of a positive value means that the machine downtime of the worker is longer than the standard, and thus evaluator 270 sets the score to a value greater than or equal to 0 and less than 5. When the machine downtime is calculated by aggregator 260 for each machine stoppage factor, evaluator 270 may calculate the deviation degree for each machine stoppage factor and change the calculated deviation degree to a score.

It is to be noted that when the specified worker handles multiple product types and multiple machines during the evaluation time period, evaluator 270 calculates, for each machine stoppage factor, the deviation degree for each of the product types based on the standard machine downtime and the machine downtime for each of the product types calculated by aggregator 260, and changes the calculated deviation degree to a score. Evaluator 270 calculates a total score for each machine stoppage factor by weighting the score for each product type using a ratio of a handling period of the product type by the specified worker to the evaluation time period and the number of produced products. The calculated total score is the score of the specified worker in the evaluation time period for each machine stoppage factor.

Evaluator 270 identifies a poor skill of the specified worker based on the deviation degree for each machine stoppage factor. More specifically, evaluator 270 compares a score for each machine stoppage factor with a threshold to identify a score lower than the threshold. Evaluator 270 identifies, as the poor skill of the specified worker, a skill for restarting a stopped machine caused by a machine stoppage factor corresponding to the identified score.

Display 280 is one example of an output unit that outputs information based on the deviation degree. In Embodiment 2, display 280 displays the score of the specified worker. When the score is calculated for each machine stoppage factor, display 280 displays the score for each machine stoppage factor. The display example of display 280 will be described later.

[2-3. Operation]

Next, the operation performed by skill evaluation device 200 according to Embodiment 2 will be described.

[2-3-1. Generation of Standard Machine Downtime Model]

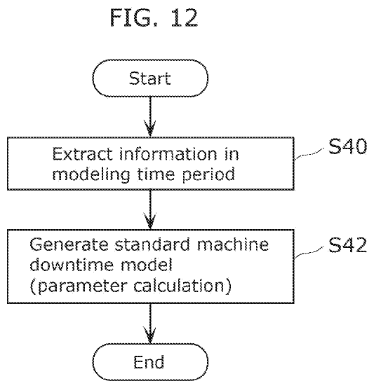

First, among operations performed by skill evaluation device 200 according to Embodiment 2, a process of generating the standard machine downtime model will be described with reference to FIG. 12. FIG. 12 is a flow chart illustrating a process of generating a standard machine downtime model among operations of the skill evaluation device according to Embodiment 2.

As shown in FIG. 12, first, first extractor 210 extracts information in the modeling time period (S40). More specifically, first extractor 210 extracts all stoppage history records except worker information 195 in the modeling time period from the past stoppage history records stored in storage 290. In other words, first extractor 210 extracts all stoppage information 296, product type information 192, machine information 193, and environment information 194 without filtering using a worker, a machine, a product type, a machine stoppage factor, an environmental value, and the like.

Next, model generator 220 generates the standard machine downtime model based on the extracted information (S42). More specifically, model generator 220 calculates parameters for defining the standard machine downtime model, based on Bayesian estimation.

The above process of generating the standard machine downtime model is performed prior to evaluation of the machine downtime of the specified worker. The process of generating the standard machine downtime model may be repeated every time the stoppage history data is accumulated. For example, the process of generating the standard machine downtime model may be performed every day or every week.

[2-3-2. Evaluation of Machine Downtime]

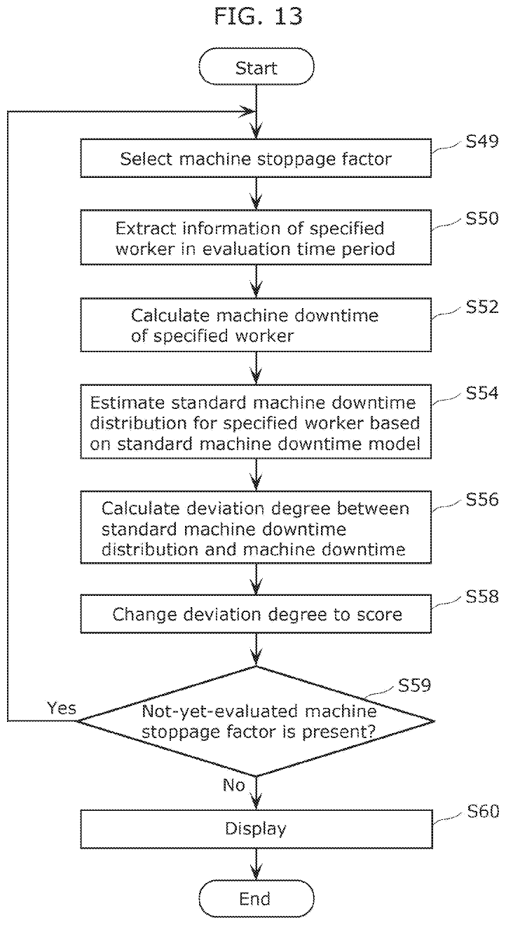

Next, among operations performed by skill evaluation device 200 according to Embodiment 2, a process of evaluating a machine downtime for a worker will be described with reference to FIG. 13. FIG. 13 is a flow chart illustrating a process of evaluating the machine downtime of a worker among the operations of the skill evaluation device according to Embodiment 2.

As shown in FIG. 13, first, second extractor 240 selects one machine stoppage factor from among multiple machine stoppage factors (S49). For example, second extractor 240 selects a machine stoppage factor for which the machine downtime is not yet evaluated.

Next, second extractor 240 extracts information of a specified worker in the evaluation time period (S50). It is to be noted that the specified worker and the evaluation time period is a worker and a time period received by input receiver 130, respectively. With reference to worker information 195, second extractor 240 extracts stoppage information 296, product type information 192, machine information 193, and environment information 194 related to products the specified worker has been involved in production of during the evaluation time period.

Next, aggregator 260 calculates the machine downtime of the specified worker due to the selected machine stoppage factor (S52). More specifically, aggregator 260 calculates an average machine downtime by aggregating the production records of the specified worker.

Next, indicator estimator 250 estimates the standard machine downtime distribution for the specified worker based on the standard machine downtime model generated by the process shown in FIG. 11 (S54). More specifically, indicator estimator 250 estimates the standard machine downtime distribution by providing product type information 192, machine information 193, and environment information 194 extracted by second extractor 240, as input data to the standard machine downtime model.

It is to be noted that one of the process by aggregator 260 or the process by indicator estimator 250 may be performed before the other, or both of them may be performed in parallel.

Next, evaluator 270 calculates the deviation degree between the standard machine downtime distribution and the machine downtime of the specified worker (S56). Furthermore, evaluator 270 changes the calculated deviation degree to a score (S58). The calculated score is a value of evaluation of whether the machine downtime of the specified worker due to the machine stoppage factor is short. The machine downtime of the specified worker is shorter as the score increases, which means that the ability to restore the machine is high.

Next, second extractor 240 determines whether a not-yet-evaluated machine stoppage factor is present (S59). When a not-yet-evaluated machine stoppage factor is present (Yes in S59), second extractor 240 selects the not-yet-evaluated machine stoppage factor (S49), and repeats Steps S50 to S59. When a not-yet-evaluated worker is not present (No in S59), i.e., when evaluation of all the machine stoppage factors which are targets for the evaluation is finished, display 280 displays the score for each worker (S60).

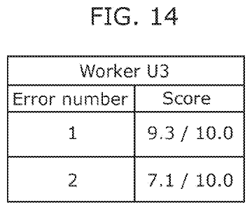

FIG. 14 is a diagram illustrating an example of a score display by the skill evaluation device according to Embodiment 2. As shown in FIG. 14, display 280 displays the score of the specified worker in a table format for each machine stoppage factor. In this manner, display 280 displays the score for each machine stoppage factor on the same screen, and thus the difference in restoring ability among the machine stoppage factors can be easily known. In other words, a good skill and a poor skill of the specified worker can be known. Accordingly, it is possible to appropriately determine training details of the specified worker by knowing his/her poor skill, which assists the improvement in skill.

It is to be noted that an example of the score display by display 280 is not particularly limited. For example, display 280 may display the score by sorting the machine stoppage factors in descending order of score. In this case, display 280 need not display a score value itself.

As described above, in skill evaluation device 200 according to Embodiment 2, the standard machine downtime distribution can be obtained based on the estimation model, and thus it is possible to equally evaluate the worker ability to restore the machine by reducing the effects of the machines, the product types, and the like.

In Embodiment 2, as is the case in Embodiment 1, the score for each machine stoppage factor may be calculated for each of the specified workers. Alternatively, the score may be calculated for each worker regardless of the machine stoppage factors.

### OTHER EMBODIMENTS

The skill evaluation device and the skill evaluation method according to one or more aspects have been described above in accordance with the embodiments, but the present disclosure is not limited to the embodiments. Various modifications to the embodiments that can be conceived by those skilled in the art and forms configured by combining components in different embodiments without departing from the spirit of the present disclosure may be included in the scope of the present disclosure.

Moreover, the communication method between the devices described in the embodiments is not particularly limited. When the devices communicate wirelessly, the wireless communication method (communication standard) is, for example, near field communication such as ZigBee (registered trademark), Bluetooth (registered trademark), or wireless local area network (LAN). Alternatively, the wireless communication method (communication standard) may be communication via a wide area communication network such as the Internet. The devices also communicate by wire instead of the wireless communication. Specifically, the wired communication is power line communication (PLC), communication using a wired LAN, or the like.

Moreover, in the above embodiments, a process performed by a specified processing unit may be performed by another processing unit. The processing order of processes may be changed, or processes may be performed in parallel. The allocation of components in the skill evaluation device to the devices is one example. For example, a component in one of the devices may be included in the other device.

For example, the processes described in the above embodiments may be performed by a single device (system) as integrated processing, or by multiple devices as distributed processing. The processor that executes the above program may be singular or plural. In other words, the processor may perform the integrated processing or the distributed processing.

In the above embodiments, all or a part of the components such as a controller may be configured with dedicated hardware, or may be implemented by executing a software program suitable for each component. Each component may be implemented by a program executer such as a central processing unit (CPU) or a processor reading and executing a software program recorded on a recording medium such as a HDD or a semiconductor memory.

The component such as a controller may be configured in one or more electronic circuits. The one or more electronic circuits may be each a general-purpose circuit or a dedicated circuit.

The one or more electronic circuits may include, for example, a semiconductor device, an IC, or a LSI circuit. The IC or LSI circuit may be integrated into a single chip or multiple chips. Due to a difference in the degree of integration, the electronic circuit referred here to as an IC or LSI circuit may be referred to as a system LSI circuit, s very large scale integration (VLSI) circuit, or an ultra large scale integration (ULSI) circuit. A field programmable gate array (FPGA) which is programmable after manufacturing of the LSI circuit also can be used for the same purposes.

Moreover, these general and specific aspects of the present disclosure may be implemented using a system, a device, a method, an integrated circuit, or a computer program. Alternatively, these may be implemented using a non-transitory computer-readable recording medium such as an optical disk, HDD, or semiconductor memory storing the computer program. These also may be implemented using any combination of systems, devices, methods, integrated circuits, computer programs, or recording media.

Moreover, in each of the embodiments described above, variations, replacement, addition, omission, or the like may be made within the scope of Claims or the equivalent scope.

### INDUSTRIAL APPLICABILITY

The present disclosure is applicable as a skill evaluation device capable of equally evaluating a worker skill. For example, the present disclosure is applicable to a factory production system or the like.

1. A skill evaluation device comprising:
an obtainer that obtains first information indicating one or more types of first products produced during a first time period, machines used in production of the first products, and skill indicators of workers involved in production of the first products;
a model generator that generates an estimation model for estimating a standard probability distribution of a skill indicator in the first time period, using the first information;
an aggregator that calculates a skill indicator of a specified worker by aggregating production records of the specified worker in a second time period;
an estimator that estimates a probability distribution of the skill indicator for the specified worker by providing, as input data to the estimation model, second information indicating: one or more types of second products the specified worker has been involved in production of during the second time period; and one or more machines used by the specified worker during the second time period;
a calculator that calculates a deviation degree between the probability distribution estimated by the estimator and the skill indicator calculated by the aggregator; and
an output unit that outputs information based on the deviation degree.

2. The skill evaluation device according to claim 1, wherein
the skill indicator is an indicator indicating worker productivity.

3. The skill evaluation device according to claim 1, wherein
the skill indicator is a machine downtime required for a worker to restart a stopped machine.

4. The skill evaluation device according to claim 3, wherein
the aggregator calculates the machine downtime for each of machine stoppage factors by aggregating the production records of the specified worker in the second time period for each of the machine stoppage factors, and
the calculator calculates the deviation degree for each of the machine stoppage factors.

5. The skill evaluation device according to claim 4, wherein
the calculator identifies a poor skill of the specified worker based on the deviation degree for each of the machine stoppage factors.

6. The skill evaluation device according to claim 1, wherein
the specified worker comprises a plurality of specified workers,
the aggregator calculates the skill indicator for each of the plurality of specified workers,
the estimator calculates the probability distribution of the skill indicator for each of the plurality of specified workers, and
the calculator calculates the deviation degree for each of the plurality of specified workers.

7. The skill evaluation device according to claim 1, further comprising:
an input receiver that receives an input of the second time period and an input of one or more specified workers.

8. A skill evaluation method comprising:
obtaining first information indicating one or more types of first products produced during a first time period, machines used in production of the first products, and skill indicators of workers involved in production of the first products;
generating an estimation model for estimating a standard probability distribution of a skill indicator in the first time period, using the first information;
calculating a skill indicator of a specified worker by aggregating production records of the specified worker in a second time period;
estimating a probability distribution of the skill indicator for the specified worker by providing, as input data to the estimation model, second information indicating: one or more types of second products the specified worker has been involved in production of during the second time period; and one or more machines used by the specified worker during the second time period;
calculating a deviation degree between the probability distribution estimated in the estimating and the skill indicator calculated in the calculating of the skill indicator; and
outputting information based on the deviation degree.

9. A non-transitory computer-readable recording medium for use in a computer, the recording medium having a program recorded thereon for causing the computer to execute the skill evaluation method according to claim 8.
